(19) United States
(12) Patent Application Publication
(10) Pub. No.: US 2022/0053218 A1
(43) Pub. Date: Feb. 17, 2022

(54) Digital Sporting Event Viewer

(71) Applicant: Michael Malecki, Langhorne, PA (US)

(72) Inventor: Michael Malecki, Langhorne, PA (US)

(21) Appl. No.: 17/065,016

(22) Filed: Oct. 7, 2020

Related U.S. Application Data
(60) Provisional application No. 63/066,254, filed on Aug. 16, 2020.

(51) Int. Cl. H04N 21/2187; H04R 1/08; H04R 1/02; H04N 21/4788; H04N 21/2543; H04N 21/258; G06Q 30/06; G06Q 10/02; G06Q 50/00; G06Q 20/12; G06Q 30/00; G06Q 20/04

(52) U.S. Cl. CPC H04N 21/2187; H04R 1/08; H04R 1/028; H04N 21/4788; H04N 21/2543; G06Q 20/0457; G06Q 30/0633; G06Q 10/02; G06Q 50/01; G06Q 20/127; G06Q 30/0185; H04N 21/25875

(57) ABSTRACT

The device of the present invention transmits live events to remote authorized user devices. More specifically, the digital device of the present invention is placed in a seat in a venue hosting a live event, and is wirelessly connected to an electronic device of an authenticated user who paid for the seat but is remote from the venue. The device transmits the live event from the venue to the user's device, thereby enabling the user to remotely attend and participate in the live event via his or her user device. The various position and characteristics of the components of the digital device can be modified remotely by the user through a user interface present in the user device via a smartphone application.

### CROSS-REFERENCE TO RELATED APPLICATION

The present application claims priority to, and the benefit of, U.S. Provisional Application No. 63/066,254, which was filed on Aug. 16, 2020, and is incorporated herein by reference in its entirety.

### BACKGROUND

The present invention relates generally to the field of transmission of a live event feed to a remote device. More specifically, the present invention relates to a digital device having a camera system, a plurality of audio speakers and a microphone, placed on or attached to a seat within a theatre, arena, stadium of the like. The device of the present invention transmits live events to authorized user devices, such as smartphones, laptops, portable media player devices, portable video game consoles, tablets, AR/VR headsets, portable e-book reader devices, etc. More specifically, the digital device of the present invention is placed/installed in an arena or stadium and is wirelessly connected to an electronic device of a user who purchased a ticket for the seat on which the digital device is attached. The device then transmits the live event from the stadium or arena to the user's device, thereby helping people to feel like they are attending the live event without being physically present in the arena, theater, or stadium. Further, the microphone of the digital device records the sound and audio feedback from the live event, and enables the remote user to cheer, which is relayed back to the stadium through speakers along with other users that have connected to similar devices and have purchased tickets to the event. The audio signal, along with camera feeds, is transmitted to the user device through a Wi-Fi signal and related internet connection. The various position and characteristics of the components of the digital device can be changed by the user through a user interface present in the user device via a smartphone application. The digital device has wireless connectivity functionality, such as a Wi-Fi connection module, a 3G/4G/LTE cellular connection module or the like, to transmit the live event to the user device. Accordingly, the present disclosure makes specific reference thereto. Nonetheless, it is to be appreciated that aspects of the present invention are also equally applicable to other like applications, devices and methods of manufacture.

By way of background, in order to access a live event in-person, such as a game, play, event, concert or the like, most people have to buy a ticket to enter into the stadium, theater, arena, auditorium or other location where the live event is being held or staged. More specifically, the person has to show the purchased ticket, either in physical or electronic form, to authenticate and obtain entry. Once inside the event, the person typically sits or stands in an assigned location to watch the game/event/play.

Nonetheless, there are many instances in which the person who purchased the ticket for the event cannot attend the live event in-person. For example, a scheduling conflict may arise, the person may become ill, or the individual may simply lack transportation to or from the event. Since the person is unable to attend the event in-person, the money spent to purchase the ticket for the event is essentially wasted, and the individual is deprived of the experience of witnessing the event.

Additionally, because of the COVID-19 pandemic, many people are prohibited from attending, or simply do not wish to attend, a live event because of the fear of contracting a serious illness or disease. Further, due to the current pandemic, many events are taking place without audiences or crowds, which prevents people from being able to watch and participate in the event in person. The inability to have in person attendance at such events has caused event organizers to suffer significant financial hardship, as well as those businesses in close proximity to the events venue, such as parking lot vendors, restaurants, bars, souvenir shops and the like.

Some passionate fans also love to watch the event from a particular seat or area within the stadium of venue to have a specific view or vantage point. Since the user is unable to attend the event in-person and is unable to watch the event from the particular seat, many fans are left feeling unfulfilled and disappointed. Additionally, current television broadcasts of such sporting and other events provide a broad perspective on the event, but lack personalization. Further, such televised broadcasts do not provide the fan with the same sense and feeling of being present at the event, as the fan is unable to cheer on their team with similar like-minded fans, or feel like they are part of the action.

Therefore, there exists a long-felt need in the art for a communication system and method that enables people to virtually attend live events, such as sporting events, concerts, and the like, without physically traveling to the event. There is also a long-felt need in the art for a communication or remote participation system and method that provides a user with a digital and personalized view of the event without being physically present at the event. Moreover, there is a long-felt need in the art for a communication or remote participation system and method that allows a person to cheer, change a field view, and/or increase or decrease the audible levels of the event via an electronic device, such as a smartphone, tablet, laptop, computer or the like. Additionally, there is a long-felt need in the art for a communication or remote participation system and method that can be used to transmit live events from any venue, such as a sports venue, theater, auditorium, etc., and that uses conventional Wi-Fi and/or cellular technology to transmit live event video and audio to a user device in real time. Also, there is a long-felt need in the art for a communication or remote participation system and method that enables event organizers to generate ticketing revenue by offering an authentic and personalized view to the subscribers in the event of a pandemic or other situation or emergency which prevents people from physically attending the events. Finally, there is a long-felt need in the art for a communication system and method that is relatively inexpensive to manufacture and that is safe and easy to use.

The subject matter disclosed and claimed herein, in one embodiment thereof, comprises a system for communication and interaction between a digital sporting event viewer device placed in a seat or other location at a venue, and a user electronic device carried and utilized by a subscriber. The digital sporting event viewer device comprises wide-angle cameras to generate a stream of real-time live video data, a microphone for recording real-time audio data, speakers to output the cheer made by the user on the electronic device, clips or other fasteners to secure the digital sporting event viewer device onto a seat in the venue, a Wi-Fi module or 3G/4G/LTE/5G communication module to wirelessly transmit live event video and audio to the user device and to receive instructions to change the camera and microphone settings of the viewer device from the user device. The cameras and microphone of the viewer device may feed the video and audio content into a controller system, which may then transmit and interact with the remote mobile device of a user who is authorized to receive the same at a remote location.

In this manner, the novel system of the present invention accomplishes all of the forgoing objectives and provides a relatively safe, easy, convenient and cost-effective solution to enable a viewer to watch and participate in a live event from a remote location and on a personalized basis. The live content received by the authorized user can be viewed on a browser or a compatible app on any device such as a smartphone, laptop, portable media player device, portable video game console, tablet, AR/VR headset, portable e-book reader device, etc.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for transmitting a real-time feed of a live event from a digital sporting event viewer device securely placed on a seat in an event venue to an authorized electronic device of a user who purchased a ticket for the seat. The digital sporting event viewer device comprises a processor to execute instructions to control and transmit the live feed, memory to store the live feed, wide angle cameras to generate a stream of real-time live video, a microphone for recording real-time audio, speakers to output the communications made by the remote user, seat clips or fasteners to secure the digital sporting event viewer device onto the stadium or arena seat, and a Wi-Fi module or 3G/4G/LTE/5G communication module to wirelessly transmit live event video and audio to establish a wireless connection to the authorized electronic device of the user.

The user is authenticated with a suitable mechanism, such as an OTP, ticket ID or any other credential, before getting access to the live feed of the event. The credentials are authorized by event servers, and the user will receive access once his or her credentials have been verified and the user has paid for access to the system. Once access has been granted, the user or subscriber watches the live feed on a browser or an associated smartphone application with the same view the user would have seen if he or she was physically present in the stadium. The user can also adjust the controls present on the user interface on the electronic device to turn ON/OFF the viewer device, change the settings of the components of the viewer device (i.e. changing the angle of the cameras), increase or decrease the sound of speakers of the digital sporting event viewer device, cheer on the teams by using microphones, etc. Such aspects allow for the user to enjoy a more personalized interaction with the live event, without physically attending the same for any of the reasons stated above. Other features of the present invention may allow a subscriber to connect with other system users to, for example, chat or exchange comments on the live event or any other topic. The system may also collect messages and sounds from a group of subscribers for playback at the event location, thereby allowing users to sing songs, or engage in chanting and other fan related activities. In addition, the subscriber may be provided with links so that he or she can order food for delivery, as well as have souvenirs or other memorabilia from the live event shipped to their home.

In a further embodiment of the present invention, a digital sporting event viewer device to enable a user to stream live audio and video content and remotely participate in a live event is disclosed. More specifically, the digital sporting event viewer device is a portable apparatus that is securely placed on a seat or other suitable location, such as along a sideline or courtside at an event venue. Once the viewer device is switched on manually or automatically (i.e., programmed to switch on at the start time of the live event), the components of the viewer device start working in conjunction to transmit the live event to a user's smartphone, tablet, AR/VR headset, etc. The digital sporting event viewer device has a processor to execute instructions to control and transmit the live audio and video feed, memory to store the live feed, wide-angle cameras to generate a stream of real-time video data, a microphone for recording real-time audio data, speakers to output the cheer or other comments made by the remote user, clips, fasteners or a stand to secure or place the digital sporting event viewer device onto the stadium or arena seat, and a Wi-Fi module or 3G/4G/LTE/5G communication module to wirelessly transmit the live event video to establish a wireless connection to the authorized electronic device of the user.

In a further embodiment of the present invention, a method for the transmission of personalized real time video and audio feed of a live event to an electronic device of an authorized user is disclosed. The method comprises initially authorizing the electronic device of the user through a credential and, upon being authorized, establishing a wireless connection between the user device and a digital sporting event viewer device installed or placed at the user's selected location at the venue of the live event. The real time audio and video of the live event are then streamed from the viewer device to the electronic device, wherein the video is captured by wide-angle cameras of the viewer device and the audio is captured by the microphone of the viewer device.

In yet further embodiment of the present invention, a non-transitory computer-readable storage medium is described. The non-transitory, computer-readable storage medium has embodied thereon a program executable by a processor to perform a program method for the transmission of personalized and authorized live video and audio feed of a live event. The steps for establishing a wireless connection between a user device and a digital sporting event viewer device installed at the seat for which the user has made payment are comprised of capturing the live video by the cameras present in the viewer device, capturing the live audio by the microphone of the viewer device, and streaming the live audio and video of the event from the viewer device to the user device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the digital sporting communication system of the present invention in accordance with the disclosed architecture;

FIG. 2 illustrates a perspective view of one potential embodiment of the digital sporting event viewer device of the present invention in accordance with the disclosed architecture;

FIG. 3 illustrates a perspective view of potential embodiments of a user interacting with live content on a handheld or virtual reality device received from the digital sporting event viewer device of the present invention in accordance with the disclosed architecture;

FIG. 4 illustrates a perspective view of one potential embodiment of the user device of the digital sporting communication system of the present invention in accordance with the disclosed architecture;

FIG. 5 illustrates a flow chart depicting one potential embodiment of a method of authenticating and authorizing a user to access a live event from the handheld device and connecting to a viewer device of the digital sporting communication system of the present invention in accordance with the disclosed architecture; and

FIG. 6 illustrates a flow chart depicting one potential embodiment of a method of viewing a live event by an authenticated user using the digital sporting event viewer of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a communication system and method that enables individuals to virtually attend live events, such as a sporting event, concerts, and the like, without physically traveling to the event. There is also a long-felt need in the art for a communication or remote participation system and method that provides a user with a digital and personalized view of the event without the user being physically present at the event, and that allows an individual to cheer, change a field view, and/or increase or decrease the audible levels of the event via an electronic device, such as a smartphone, tablet, laptop, computer of the like. Additionally, there is a long-felt need in the art for a communication or remote participation system and method that can be used to transmit live events from any venue, such as a sports arena, theater, auditorium, etc., and that uses conventional Wi-Fi and/or cellular technology to transmit live event video and audio to a user device in real time. Also, there is a long-felt need in the art for a communication or remote participation system and method that enables event organizers to generate ticketing revenue by offering an authentic and personalized view to the subscribers in the event of a pandemic or other situation or emergency which prevents people from physically attending various events.

The present invention, in one exemplary embodiment, is a system for transmitting a real time audio and visual feed of a live event from a digital sporting event viewer device securely placed on a seat or other location in an event venue to an authorized electronic device of a user who purchased a ticket for the seat on which the viewer device is placed or positioned. The digital sporting event viewer device includes a processor to execute instructions to control and transmit the live feed, a memory to store the live feed, wide-angle cameras to generate a stream of real-time live video data, a microphone for recording real-time audio data, speakers to output the cheers or other communication from the remote user, clips, fasteners or a stand to secure the digital sporting event viewer device onto the seat in the stadium or venue, and a Wi-Fi module or 3G/4G/LTE/5G communication module to establish a wireless connection between the viewer device and the authorized electronic device of the user.

The user may use the system of the present invention to watch the live feed on a browser or an associated smartphone app with the same view as the user would have seen if he or she was physically present at the live event. Additionally, the user, through controls present on the user interface of the electronic device, can change the settings of the various components, such as turning the viewer device ON/OFF, changing the angle of the cameras, and increasing or decreasing the sound of speakers of the digital sporting event viewer device to have a more personalized interaction with the live event from a remote location. Other features of the present invention allow a subscriber to connect with other system users to chat and/or exchange comments during the event. The system may also collect messages and sounds from a group of subscribers for playback at the event location, thereby allowing users to sing songs, engage in chanting and other fan related activities. In addition, the system may provide the subscriber with links that enable the subscriber to order food for delivery, as well as purchase souvenirs or other memorabilia from the event and have the same shipped to their home.

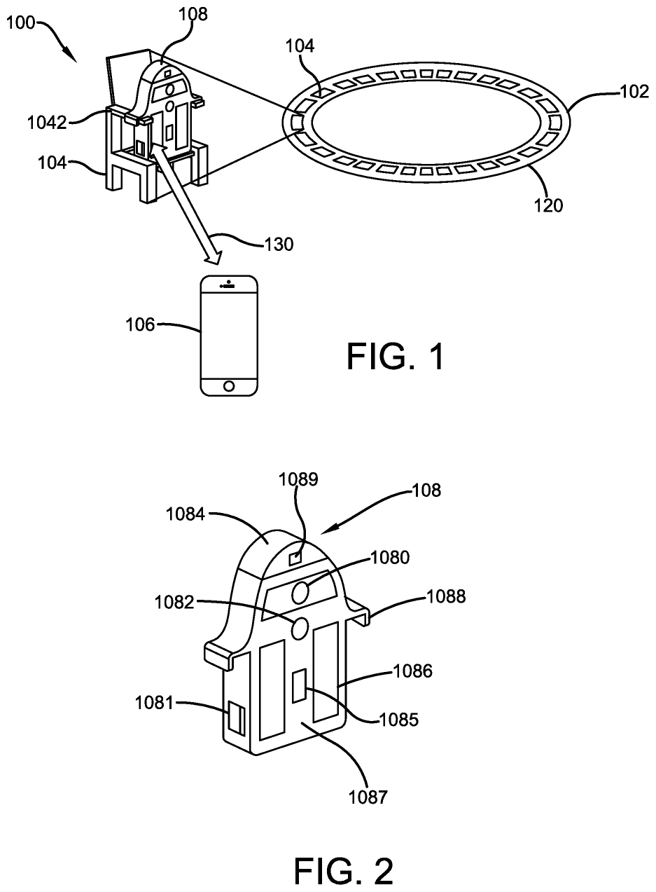

Referring initially to the drawings, FIG. 1 illustrates a perspective view of one potential embodiment of the digital sporting communication system 100 of the present invention in accordance with the disclosed architecture. More specifically, FIG. 1 depicts the system 100 being used in conjunction with a live event being staged or held at a venue 120 having a seating area 102 for the crowd or audience to sit and watch the event in-person. The seating area 102 is comprised of a plurality of seats 104, which are booked by people by purchasing a ticket as per their choice. The digital sporting communication system 100 is comprised of a digital sporting event viewer device 108 that may be placed on the seat 104 (or any other location in the venue to obtain a particular vantage point) booked by a user who cannot travel to the venue 120 to watch the event in-person. The digital sporting event viewer device 108 enables the user to watch, and participate in, the live event remotely on his or her handheld device 106, such as a mobile phone, tablet, computer, etc. The viewer device 108 may be secured to the seat 104 by any suitable means, such as via the use of adjustable seat clips, stands, fasteners, etc.

Once the live event is about to start, or on a request from the user on the handheld device 106, a wireless connection 130 is established between the handheld device 106 and the viewer device 108 through a wireless connection, for example, via Wi-Fi or 3G/4G/LTE/5G signal. The transmission of the live event from the viewer device 108 to the handheld device 106 may also pass through a private network, public Internet, or a secure tunnel such as a Virtual Private Network (VPN), or any other communication medium.

Once the wireless connection 130 is established, live audio and video streaming begins from the viewer device 108 to the handheld device 108. A separate viewer device 108 may be placed or installed on each seat 104 in the venue 102 for different users to obtain a personalized view similar to the view the user would have if experiencing the live event in person. Alternatively, in one embodiment, a viewer device 108 on a seat 104 may be used to transmit a live stream of the event to multiple users, such as family members, so that all the family members can collectively watch the live event on their respective handheld or other devices 106.

The venue 120 shown in FIG. 1 may be any type of venue used to host any type of event, public or private. For instance, the event venue 120 may be a venue for any type of entertainment or cultural event that may be presented at a theater, stadium, arena, concert hall, or other facility that is capable of accommodating a group of people. Further, events to be viewed may include football, baseball, soccer, ice hockey, basketball, rugby, cricket, tennis, motor sports (such as automobile racing), horse racing, Olympic games, and the like; cultural events such as concerts, music festivals, plays, or the opera, and the like; religious events; and more permanent exhibitions such as museums, historic homes, and the like.

FIG. 2 illustrates a perspective view of one potential embodiment of the digital sporting event viewer device 108 of the present invention in accordance with the disclosed architecture. More specifically, the event viewer device 108 is comprised of a wireless communication module 1084 that enables the viewer device 108 to transmit and receive wireless signals to and from the user handheld or other device 106. The wireless communication module 1084 can communicate using 3G/4G/LTE/5G and/or a 802.11 data communications network. The viewer device 108 is also comprised of one or more wide-angle cameras 1080 to capture a widefield of view of the live event, wherein the focal length and angle of the camera 1080 can be changed by the user through an input on the viewer device app. The viewer device 108 is also comprised of a microphone 1082 and one or more speakers 1086. The microphone 1082 captures the sounds and audio of the live event, and sends the same, along with the video stream, to the remote user in real-time or with minimal delay. Conversely, the speakers 1086 of the viewer device 108 output the cheers or any other sound or communication produced by the remote user from his or her handheld device 106.

In a further preferred embodiment, the viewer device 108 may also comprise a display screen to display the live video of the user watching the live event on the handheld device 106, which is in wireless communication with the viewer device 108. A motherboard 1087 controls the execution of the various instructions, and also has a processor to coordinate the functions of the above-described hardware components. The motherboard 1087 works as a main controller for the viewer device 108. The processor can be configured, for example, as a 16-bit microprocessor, and external pins of the processor are generally coupled to an internal bus so that it can be interconnected to respective components of the viewer device 108. Notwithstanding, those skilled in the art should appreciate that other hardware configurations can also be utilized with or in the digital sporting event viewer device 108. For example, hardware/software may also be included that provides the user with the ability to order food, souvenirs, memorabilia, etc. to be delivered to the home of the user.

As previously mentioned, the viewer device 108 may be securely placed on the seat 104 through clips or other fasteners 1088, so that it does not slip and remains secure on the seat 104 during the entire live event. Accordingly, based on the above, it should be appreciated that the viewer device 108 of the present invention is like a virtual avatar of the remote user, and gives the user the feeling of the in-person atmosphere of the venue 120. In addition to the live event, the viewer device 108 may also transmit team information, venue information and other entertaining activities happening at the venue, as well as providing the user with the ability to interact with other individuals watching the event via on-line chat rooms or the like.

Additionally, the viewer device 108 may further comprise a memory 1089 or cloud storage to store the live transmission that may be accessed at a later date or time by the user, as well as a battery 1081 for powering the viewer device 108. The battery 1081 may be a single-use battery, or a rechargeable battery. For example, in a preferred embodiment, battery 1081 may be one or more NiMH batteries, which have properties that reduce the probability of overheating and decrease recharging requirements, as opposed to using lithium-ion or lithium polymer batteries (LiPo). Alternatively, the viewer device 108 may include a wired connection or a USB port 1081 for connecting to a power supply from an external source, such as a wall-outlet, for the operation of the viewer device 108. Further, the viewer device 108 may include an AC/DC adapter (not shown) for converting the AC power supplied from an external source, such as a wall-outlet, to a DC power for the operation of the viewer device 108.

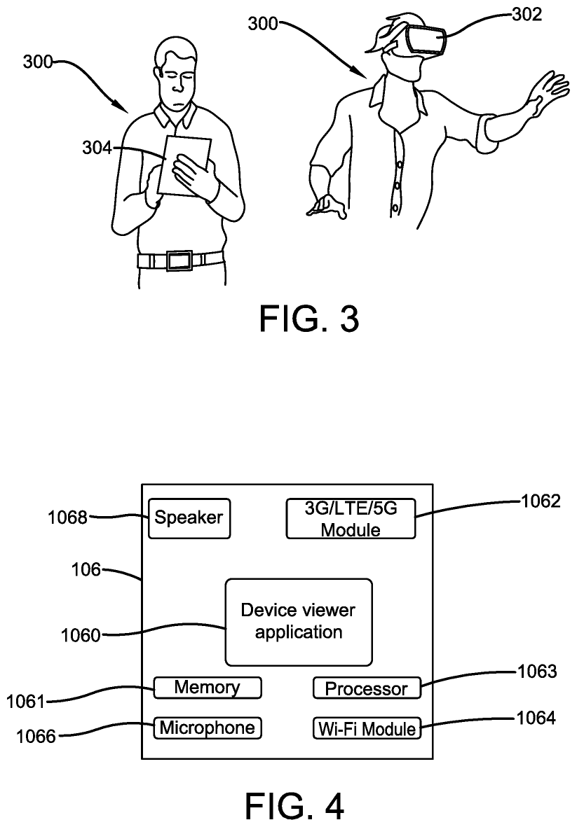

FIG. 3 illustrates a perspective view of potential embodiments of a user 300 interacting with live content on a handheld 304 or virtual reality device 302 received from the digital sporting event viewer device 108 of the present invention in accordance with the disclosed architecture. More specifically, a user 300 engages with the live content received from the viewer device 108 through wireless connection, such as the internet. The live video transmitted by viewer device 108 is encoded and streamed based on the authorized user device as per the profile of the user and previously verified credentials of the user. Alternatively, the viewer device 108 may detect the user device 106 in real-time, and encode the live stream accordingly. The user device 106 can be a personal computer, handheld computing device, telephone, mobile computing device, tablet, laptop, e-book reader, workstation, an AR headset, virtual reality (VR) headset or any other computing device. As an example, FIG. 3 illustrates the user 300 engaging with the content on a tablet 304, and also a AR/VR headset 302. The user 300 can also write comments and share audio messages, which can be relayed to those present at the live event via the viewer device 108, such as a tablet 304 or AR/VR headset 302. The user 300 may also download and store at least part of the live video and/or audio stream to the handheld device 304 or 302, for replay at a later date and/or time, based on the preferences of the user.

The user 300 may see a mosaic of friends on social media platforms, such as Facebook, Twitter, Instagram and others, who are currently viewing the live event from their respective personal handheld devices 106, or attending the live event in-person. Also, users 300 can chat on a live chat window available on their screens. The mosaic may also be shown on a display screen at the event venue. The user 300 may also hear the augmented crowd cheering and noise, customized as per the seat of the user 300, for which payment is made by the user 300. Through the input controls given on the viewer device application, the user 300 can also change (a) the angle, resolution or zoom level of the camera 1080 of the viewer device 108, (b) the power level of the microphone and/or (c) send any other instruction to make the interaction livelier and more personal.

FIG. 4 illustrates a perspective view of one potential embodiment of the user device 106 of the digital sporting communication system 100 of the present invention in accordance with the disclosed architecture. More specifically, the user device 106 comprises one or more processors 1063, memory 1061, a microphone 1066 and a speaker 1068. The processor 1063 executes the device viewer application 1060, which provides the user a virtual seat graphical user interface (GUI) to allow the user to view a live event and interact with an event viewer device placed at the venue. In order to do so, the user would login to the device viewer application 1060 or to a web portal through a browser application for authentication before getting access to the live event view. The device viewer application 1060 is used to directly control the viewer device 108. The user device 106 has a Wi-Fi Module 1064 and 3G/LTE/5G module 1062 to establish a wireless connection with the viewer device. The microphone 1066 and the speaker 1068 of the user device 106 sends the user's cheers, communications and feedback to the viewer device 108, and the user device 106 receives the audio and video stream from the live event at the venue, respectively.

The device viewer application 1060 can be downloaded from a play store, such as the Google Play store, Apple store or any other similar app store. The software application 1060 may also show a virtual avatar of the user on the display screen of the user device 106, and also on the display of the viewer device 108 placed on the seat at the venue. The application 1060 may also give the user a chance to play interactive games and win rewards to increase the engagement of the user in the live event.

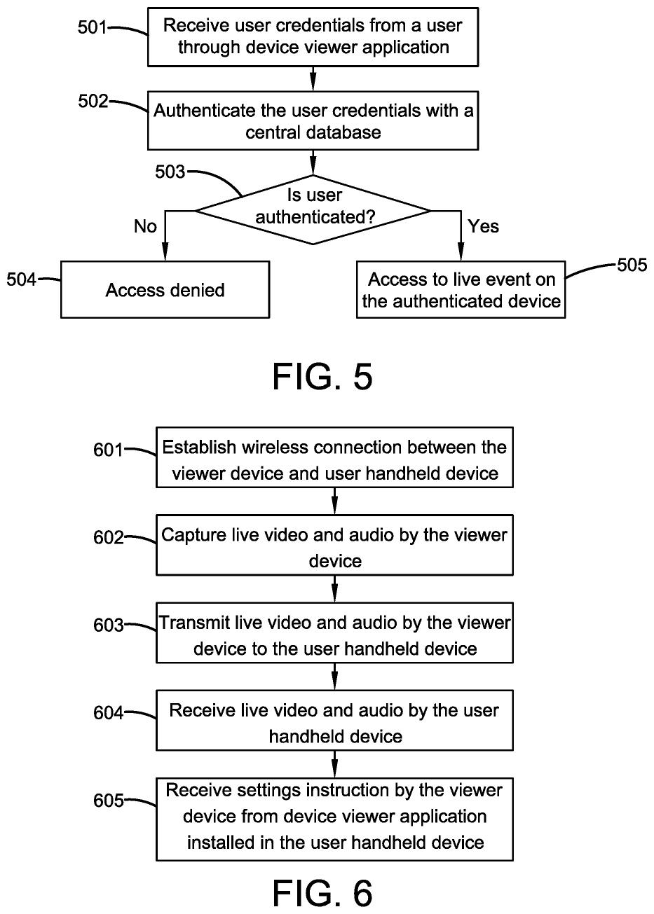

FIG. 5 illustrates a flow chart depicting one potential embodiment of a method of authenticating and authorizing a user to access a live event from a handheld device 106 and connecting to a viewer device 108 of the digital sporting communication system 100 of the present invention in accordance with the disclosed architecture. More specifically, at step 501, a user who desires to remotely watch and participate in a live event from a handheld electronic device 106 enters corresponding login credentials including, for example, a user ID, password, ticket number, etc. into the device viewer application 1060. At step 502, the device viewer application 1060 connects to a central server having an account database to authenticate the user based on the entered information. Payment information may also be verified in order to give access to the user. At step 503, authentication of the user is determined. If the user is not able to be authenticated, access is denied at step 504, and the user must return to step 501. If, on the other hand, the user is authenticated, then the user is granted access to the live event at step 505. Once access is granted, the user will be able to take advantage of additional features of the system 100 such as ordering food, souvenirs, merchandise and the like for delivery at step 510, and/or being able to chat with other authorized users at step 512. Regardless of the user's participation in these ancillary activities, once authenticated, the user can remotely receive and participate in the live event via the system 100 as described herein.

FIG. 6 illustrates a flow chart depicting one potential embodiment of a method of viewing and participating in a live event by an authenticated user via the digital sporting event viewer 108 of the present invention 100 in accordance with the disclosed architecture. More specifically, at step 601, a secure wireless connection is established between the viewer device 108 and the user's handheld device 106 using wireless technology known in the art, such as 802.11 and/or 3G/4G/LTE/5G. At step 602, the wide-angle cameras 1080 of the viewer device 108 capture the video, and the microphone 1082 of the viewer device 1080 captures the audio and noise of the live event. At step 603, the captured live video and audio are streamed via the wireless connection in real-time to the user's handheld device 106, and at step 604, the user receives the live content on the handheld device 106 and engages with the content in the various manners described herein. For example, at step 605, the user may send instruction to the motherboard of the viewer device 108 to change the camera 1080, microphone 1082 and speaker settings of the viewer device 108 as per his/her preferences, using a corresponding software application installed on the viewer device 108. The user may also utilize the software application to turn ON or OFF the viewer device 108. The content received by the user is DRM-protected and is secured using cryptography. The content may be transmitted through a Content Delivery Network (CDN) in additional to the Internet Service Provider (ISP) network. The live content may be routed through a video server to the user handheld device 106, wherein the video server receives the live video from the viewer device 108.

The components contained in the user device 106 are those typically found in smartphones or computer systems that may be suitable for use with embodiments of the present invention and are intended to represent a broad category of such electronic devices that are well known in the art. Thus, the user device 106 can be a personal computer, handheld computing device, telephone, mobile computing device, tablet, laptop, e-book reader, workstation, AR headset, VR headset, or any other computing device. The computer can also include different bus configurations, networked platforms, multi-processor platforms, etc. Various operating systems can be used, including Unix, Linux, Windows, Macintosh OS, Palm OS, Android, iOS, and other suitable operating systems.

Other embodiments could include, without limitation: (a) a seat with a camera, microphone, speakers and a screen to show the user's face\location, and that has the ability to switch users depending on the user's role; (b) a seat with a camera, microphone, speakers and screen to show the user's face\location; (c) a robotic seat that can change locations and that includes a camera, microphone and speakers; and (d) a robotic seat that can change locations and that includes a camera, microphone and speakers, wherein the camera is able to move in relationship to a VR headset.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “digital sporting event viewer device”, “viewer device”, and “event viewer device” are interchangeable and refer to the digital sporting event viewer device 108 of the present invention. Similarly, as used herein “electronic device”, “handheld device”, “user handheld device”, and “user device” are interchangeable and refer to the user handheld device 106 of the present invention.

Notwithstanding the forgoing, the digital sporting communication system 100 of the present invention can have any additional software or hardware configuration as is known in the art without affecting the overall concept of the invention, provided that it accomplishes the above-stated objectives. One of ordinary skill in the art will appreciate that the size, configuration, technology and material of the digital sporting communication system 100 and its various components as shown in the FIGS. are for illustrative purposes only, and that other configurations of the digital sporting communication system 100 are well within the scope of the present disclosure.

Further, the digital sporting communication system 100 may be practiced using any network including, but not limited to, computing grid systems, distributed computing environments, cloud computing environments, and the like. These networked computing environments include hardware and software infrastructures configured to form a virtual organization that includes multiple resources that may be in geographically-dispersed locations. Although various computer elements have been illustrated herein as single computer servers or machines, these elements may operate on several different physical machines, or be combined as operating code instances running on a single physical machine.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote participation system comprising:
a subscriber;
a digital event participation device positioned at a live event and comprised of a microphone, a camera, a speaker, a transmitter, and a receiver; and
a digital receiving unit comprised of a software application for receiving and viewing a live feed of the live event from the digital event participation device, a microphone, a speaker and a receiving unit transmitter that enables the subscriber to interact with the digital event participation device, wherein the digital event participation device and the digital receiving unit are in wireless communication after the subscriber has subscribed to the remote participation system.

2. The remote participation system as recited in claim 1, wherein the digital event participation device is comprised of at least one of a clip, a fastener and a stand to position the digital event participation device at the live event.

3. The remote participation system as recited in claim 1, wherein the digital receiving unit can transmit a message from the subscriber to the digital event participation device and the digital event participation device will play the message at the live event.

4. The remote participation system as recited in claim 1 further comprising a remote subscription service for enabling the subscriber to subscribe to the remote participation system.

5. The remote participation system as recited in claim 1 further comprising a transmitting link to enable the subscriber to order a food, a souvenir or a memorabilia from the live event.

6. The remote participation system as recited in claim 1, wherein the positioning of the digital event participation device at the live event is chosen by the subscriber.

7. The remote participation system as recited in claim 1, wherein the digital receiving unit is one of a computing device, a telephone, a mobile computing device, a tablet, a laptop, an e-book reader, a workstation, an AR headset, a VR headset or a combination thereof.

8. The remote participation system as recited in claim 4, wherein the remote subscription service is comprised of a at least two subscription offerings for the subscriber to choose from.

9. The remote participation system as recited in claim 1 further comprising a chat feature permitting the subscriber to communicate with a second subscriber to the live event.

10. The remote participation system as recited in claim 1 further comprising a collection portal for receiving, collecting and playing a communication from a plurality of subscribers.

11. The remote participation system as recited in claim 1, wherein the subscriber must pay a fee to subscribe to the remote participation system.

12. A method of using a remote participation device, the method comprising the steps of;
providing a server for use by a plurality of subscribers, wherein the plurality of subscribers are able to purchase a subscription to remotely participate in a live event via a digital transmission device;
purchasing a ticket to remotely participate in the live event via the digital transmission device;
verifying the ticket; and
granting at least one of the plurality of subscribers with access to the live event via the digital transmission device.

13. The method as recited in claim 12 further comprising the step of ordering one of a food, a souvenir or a memorabilia.

14. The method as recited in claim 12 further comprising the step of communicating with at least one other subscriber as part of the live event.

15. The method as recited in claim 12 further comprising the step of receiving a live feed of the live event from the digital transmission device for viewing on one of a computing device, a telephone, a mobile computing device, a tablet, a laptop, an e-book reader, a workstation, an AR headset, a VR headset or a combination thereof.

16. The method as recited in claim 15 further comprising the step of placing the digital transmission device at the live event at a location chosen by at least one of the plurality of sub scribers.

17. The method as recited in claim 16, wherein the digital transmission device is comprised of a memory for recording the live event.

18. A digital transmission device comprising:
a processor to execute a set of instructions to control and transmit a live feed of an event;
a memory to store the live feed;
a camera to capture the event;
a microphone for recording sound at the event; and
a speaker for generating sound from the event.

19. The digital transmission device as recited in claim 18 further comprising at least one of a clip, a fastener, or a stand to position the digital transmission device at the event.

20. The digital transmission device as recited in claim 18 further comprising a wireless communication module.
